(19) United States
(12) Patent Application Publication
(10) Pub. No.: US 2014/0295956 A1
(43) Pub. Date: Oct. 2, 2014

(54) CENTRAL ACCOUNT MANAGEMENT SYSTEM FOR USER PROFILING

(71) Applicant: CAMS, LLC, Los Angeles, CA (US)

(72) Inventors: Matthew G. Katz, Los Angeles, CA (US); Jeffrey Sawitke, Mentor, OH (US)

(21) Appl. No.: 14/300,203

(22) Filed: Jun. 9, 2014

Related U.S. Application Data
(63) Continuation-in-part of application No. 13/901,527, filed on May 23, 2013.
(60) Provisional application No. 61/650,970, filed on May 23, 2012.

(51) Int. Cl. G07F 17/32; G06F 17/30

(52) U.S. Cl. CPC G07F 17/3241; G06F 17/30867
USPC 463/29

(57) ABSTRACT

Aspects of the subject technology provide a central account management system (CAMS) configured for generating a user profile, and implementing the user profile to determine whether certain user behaviors should be permitted. In certain implementations, systems of the subject technology can be configured for receiving a plurality of user information items via a network, generating a first profile based on the plurality of user information items, receiving a request for the first user, and evaluating the request using the first profile to determine if the request should be granted. Computer-implemented methods and machine readable media are also provided.

### CROSS-REFERENCE TO RELATED APPLICATIONS

The present Application is a continuation-in-part of U.S. application Ser. No. 13/901,527, filed on May 23, 2013, entitled “METHOD AND SYSTEM FOR ONLINE WAGERING COMPLIANCE,” which claims priority to U.S. Provisional Application No. 61/650,970, filed May 23, 2012, entitled “METHOD AND SYSTEM FOR ONLINE WAGERING COMPLIANCE”, both of which are entirely incorporated by reference herein.

### BACKGROUND

1. Field

The present application relates generally to managing online service accounts, and in particular, to building user profiles for use by operators in a shared network.

2. Background

The Internet has made way for new types of online services, many of which involve having a user establish an online service account in order to use the service offered at a given online service website. By way of example, online services can include, but are not limited to, email, shopping, social networking, content access, wagering, etc. Online wagering or gambling services can include, for example, poker, casino games (e.g., roulette, blackjack, pachinko, baccarat), sports betting, social gaming, horse race betting, bingo, lotteries, in-play gambling, or the like.

Some online services (e.g., online wagering) introduce various issues, such as, regulatory compliance, fraud and risk mitigation, user/player account limits, payout management, gambling addiction, or the like. Moreover, the handling of such issues may be ineffective if the bodies/agencies responsible for handling such issues are disorganized or do not communicate with each other. Accordingly, there is a need for a central account management system for such online services. Furthermore, there is a need to enable a central account management system to facilitate the aggregation and sharing of user information so that separate services can independently determine how to provide or restrict user account services.

### SUMMARY

Illustrative embodiments of the present invention that are shown in the drawings are summarized below. These and other embodiments are more fully described in the detailed description section. It is to be understood, however, that the invention is not limited to the forms described in this Summary of the Invention or in the detailed description.

In accordance with one or more aspects of the embodiments described herein, there is provided a central account management system including one or more computers, that are configured to perform operations for receiving a plurality of user information items via a network, wherein each of the user information items is provided by one or more operators, generating a first profile based on the plurality of user information items, wherein the first profile corresponds with a first user of the one or more operators and receiving a request for the first user, the request comprising an action attempted by the first user with respect to at least one of the one or more operators. In certain aspects, the one or more computers can be further configured to perform operations for evaluating the request using the first profile to determine if the request should be granted.

In another aspect, the subject disclosure provides a non-transitory computer readable medium comprising instructions stored therein, which when executed by one or more processors, cause the processors to perform operations for generating a user profile. In certain implementations, the instructions can include steps for receiving a plurality of user information items via a network, wherein each of the user information items is provided by one or more operators, generating a first profile based on the plurality of user information items, wherein the first profile corresponds with a first user of the one or more operators and receiving a request for the first user, the request comprising an action attempted by the first user with respect to at least one of the one or more operators. In certain aspects, the steps can further include evaluating the request using the first profile to determine if the request should be granted.

In yet another aspect, the subject technology is directed to a method for building a user profile, the method including receiving a plurality of user information items via a network, wherein each of the user information items is provided by one or more operators, generating a first profile based on the plurality of user information items, wherein the first profile corresponds with a first user of the one or more operators, and receiving a request for the first user, the request comprising an action attempted by the first user with respect to at least one of the one or more operators. In certain aspects, the method may further include evaluating the request using the first profile to determine if the request should be granted.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 illustrates an exemplary network that includes a central account management system, according to some aspects of the subject technology.

FIG. 2A illustrates an exemplary system for generating and managing user profiles, according to some aspects of the technology.

FIG. 2B illustrates steps of an example process for implementing a user profile that is stored and managed by a central account management system, according to some aspects of the technology.

FIG. 3 illustrates an exemplary user profile, according to some aspects of the technology.

FIG. 4 illustrates an exemplary system for registering new users.

FIG. 5 illustrates an exemplary system for authenticating returning users.

FIG. 6 illustrates an exemplary system for funding Operator accounts.

FIG. 7 illustrates an embodiment of a system for coordinating the deposit payment process.

FIG. 8 illustrates another embodiment of a system for coordinating the deposit payment process.

FIG. 9 illustrates an embodiment of a system for coordinating the withdrawal process.

FIG. 10 illustrates an embodiment of a system for coordinating the withdrawal process, wherein the central account management system is not providing payment connectivity to banking networks.

FIG. 11 shows one embodiment of a method for managing online service account(s).

FIG. 12 illustrates one embodiment of an apparatus for managing online service account(s), in accordance with the methodology of FIG. 11.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As used herein, the term exemplary refers to an embodiment that serves an example or illustration of a given concept, and does not necessarily refer to a best mode or a preferred mode.

In accordance with one or more aspects of the embodiments described herein, there is provided a method and system for managing service accounts, via one or more network entities configured for the central account management or clearing house of online services. For example, a given network entity may be referred to as a central account management entity or network entity herein, and may be one or more server(s) or the like, and may include a multi-tenant Software as a Service (SaaS) management platform. The central account management entities may be collectively referred to as a central account management system, wherein the entities may handle the communication of data in a synchronous or asynchronous manner, depending on the context or application.

As used herein, a “Partner” or “Partner instance” can refer to an entity that uses or implements an instance or version of the central account management system or the like. The Partner may optionally use or tailor their instance or version of the central account management system to engage in industry best practices or facilitate compliance with rules, laws, regulations, etc. For example, the Partner may use the system to facilitate identifying, monitoring, or managing compliance with regulations and rules across one or more industries, such as, for example, online wagering, online gambling, etc.

As used herein, an “operator” refers to any entity that integrates its online service, website, and/or software with the Partner's instance of the central account management system platform, which may be a multitenant platform running on one or more server(s), device(s), processor(s), or component(s) thereof, in operative communication with each other via wired and/or wireless network(s). The operator can abide by the Partner's system standards or the like. As used herein, a user may refer to an end customer of the operator. The user may use or interact with the operator's online service or software, and may be identified, monitored, or managed by the Partner's instance of the platform.

IDENTITY MANAGEMENT: User information may be collected by the operator and inputted into the central account management system. Alternatively, the central account management system may collect information from the User on behalf of the operator. For example, the collected information can include but is not limited to the following: internet protocol (IP) address, social security number, driver's license number, government ID, passport number, credit score data, tax return data, background check data, personally identifiable information (PII), a user device ID, voiceprint, fingerprint, facial print, retinal print, hand print, casino-operator specific account data, social profile information or geo-location data for the user, etc. The user information may include such identification information and/or payment information.

In related aspects, during the user identification process, information related to the user's device used to access the online service or software may be collected. Financial payment information may also be collected and linked to the user. Out of pocket/challenge response questions may be used to further validate the information provided by the user. Third-party databases may be utilized. Third-party vendors providing services such as, for example, device ID, internet protocol (IP) geo-location, Knowledge Based Authentication (KBA), multi-factor authentication, or the like, may be utilized.

In further related aspects, the user information may be collected across operators to generate a profile for the user. The profile may link multiple user accounts across one or more operators, across one or more Partners, across one or more access devices, and across one or more financial forms or payment for each given user. Within the central account management system, an internal profile representing the user is created to link and associate user activity across operators and partners. This profile can be referenced globally across the network as well as isolated to a particular partner instance of the system.

For example, in the exemplary context of online gaming, the user limits may be predefined by federal or state regulator(s), a consortium of online operators, individual operators, or the like, and may include self-imposed limits by the end user, best practices, etc. Additional user screening and due diligence may be implemented to adjust user limits This screening may take into consideration the following: background checks; submission of additional PII; submission of personal tax returns; credit score check.

PAYMENTS MANAGEMENT: The central account management system may be configured to enable operators to accept multiple forms of payment in multiple currencies across multiple payment channels or transaction types, including but not limited to: credit and debit card, ACH/eChecks, mail order/telephone order (MOTO) transactions, e-commerce, retail, kiosk, mobile, PayPal, Digital Wallets, mobile billing, near field communication (NFC) account data, local exchange carrier (LEC) billing, Bitcoins, or the like, as well as other emerging forms of currency, including crypto-currencies. The central account management system may be configured to enable Operators to manage taxation related to account funding, withdrawals, net withdrawals, or the like.

COMPLIANCE MANAGEMENT AND ACCOUNT RESTRICTIONS: In certain aspects, Partners can set compliance parameters and account restrictions. Participating operators and their users may be evaluated against compliance parameters, such as, for example: (a) user account deposit limit of $Y dollars across participating Operators within X amount of time for the User Level; (b) alternate account restrictions for alternate user levels; (c) game play limit restrictions based on the amount of time a user spends at a given operator's online service or on the given operator's software (e.g., 12 hours of play in a 24 hour time period); and/or (d) user's physical location or geo-location. The Account Restrictions are enforced at the operator and partner level of the central clearing house, with activity aggregated across all participating operators enabling a network wide view point to enforce compliance and account restrictions.

Account restrictions may be enforced in real-time by the central account management system. The enforced account restrictions can include, for example: account deposit restrictions; account withdrawal restrictions; game play restrictions; user account login/authentication restrictions; restrictions based on appearance of the user on a negative database or database of blacklisted customers/users; etc. Account restrictions can also be enforced in non-real-time, such as when the system receives player information from a first operator. The system may receive information from a second operator minutes later. The system may transmit notifications to both operators to take action in response to detecting one more violations of account restrictions.

Financial restrictions may be enforced by a pre-screening of the request in the central account management system if the system is not used for financial funding or withdrawals. In other words, if a service site (e.g., a gaming site) does not want to run their payments through the system, then they can pre-screen the request through the system. The request may be denied or allowed based at least in part on the pre-screen by the system. The service site would use pre-screening response information returned from the central account management system to enforce the account restrictions.

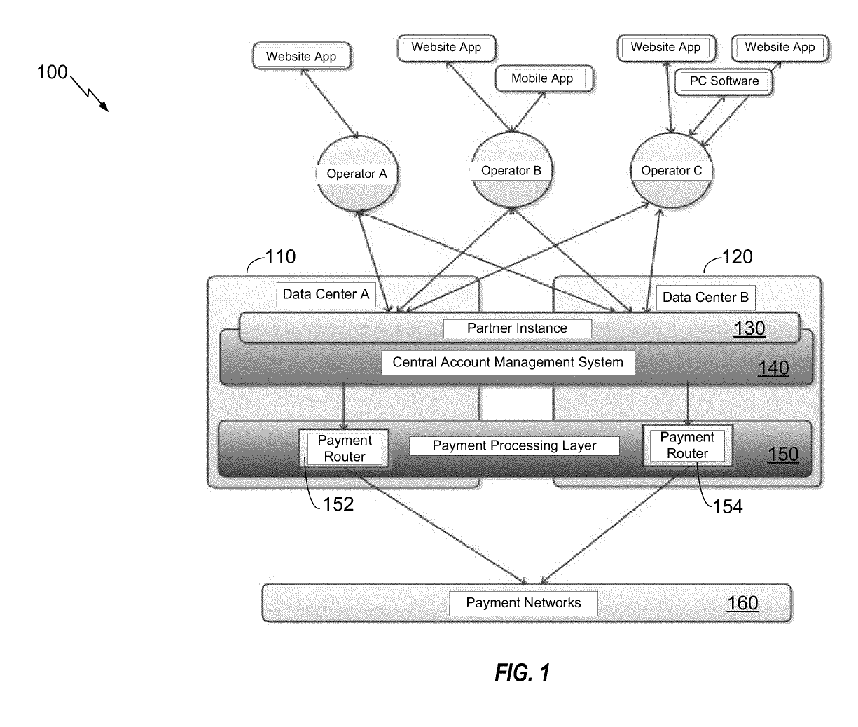

CENTRAL ACCOUNT MANAGEMENT SYSTEM OVERVIEW: FIG. 1 provides a high level overview an exemplary system 100 in which such one or more central account management system entities may be deployed. The system 100 relates to online gaming or wagering. It is noted that the principles illustrated in the system 100 are applicable to other online service sites. As shown, the operators—i.e., operators A, B, and C—represent gaming providers (e.g., casinos offering online gambling). Each Operator may be in operative communication with a website application (“app”), a mobile app, a tablet app, and/or personal computer (PC) software. Further, each Operator is in operative communication with a Partner instance 130 of the central account management system 140 using synchronous and asynchronous methods of communication. Partner instance 130 can be a white-labeled or customized version of a central account management system 140 (e.g., customized for the state of Nevada). Partner instance 130 and the system 140 can function as a clearinghouse system for online services and associated online transactions.

In the example of FIG. 1, Partner instance 130 is illustrated as being co-located with platform 140. It is noted, however, that Partner instance 130 the central account management system 140 can be in different locations, depending on the particular embodiment or application. Central account management system 140 can include or be in operative communication with a payment processor layer, such as payment processing layer 150, wherein payment processor layer 150 includes one or more payment routers (152 and 154) across one or more data centers, e.g., Data Centers A (110) and B (120) in the present example. Payment routers 152 and 154 (e.g., in payment processor layer 150) can be in operative communication with payment network(s) 160.

In the example of FIG. 1, Partner instance 130 and central account management system 140 are multi-tenant and located across Data Centers A (110) and B (120). It is noted, however, that Partner instance 130 and central account management system 140 can be located at a single data center. Operators A, B, and/or C may connect with Partner instance 130 of central account management system 140 to allow enforcement and monitoring of the Operator's user profiles across one or more Partners. The Operator's user activities may be audited across multiple channels, including, for example, website applications, mobile applications, and software installed on personal computing devices.

USER PROFILE CREATION: Aspects of the subject technology provide an account management system configured to collect user information from one or more operators. Collected user information can be used to assemble user profiles for assessing various metrics for an associated user. As such, a profile for a user can be used to control user actions or behavior with respect to various operators. For example, a user profile can include a risk profile that is used to determine a cumulative betting limit for a particular user that can then be implemented across multiple operators in a central account management system (CAMS) network. By using user-specific risk profiles to determine betting limit, restrictions can be enforced on a user-by-user basis, without regard to method of payment or user device type. Although in certain contexts, betting limit restrictions can indicate a maximum amount of financial wagering for a user, betting limits can also apply to game minimums, such as a minimum wager amount or buy in.

In certain aspects, various types of user information are collected for a particular user and then provided to CAMS, e.g., via a shared network. Pooled information is then used to build a specific risk model for the user based on user, network, operator and usage information. Accordingly, in certain implementations, CAMS provides a means by which user information is aggregated/shared between multiple operators and used to assemble user-specific profiles for the benefit of participating operators.

Although risk profiles can be based on an accumulation of information provided by different operators, the profiles may be differently implemented as between different operators. As such, operators subject to different regulatory restrictions can define different thresholds or limits for user behavior (e.g., betting restrictions), that are independently implemented based on a common profile. For example, a particular user's betting threshold may be lower at Operator A if the jurisdiction of Operator A is subject to more stringent regulatory controls, e.g., that are embodied in Operator A's risk profile implementation policy.

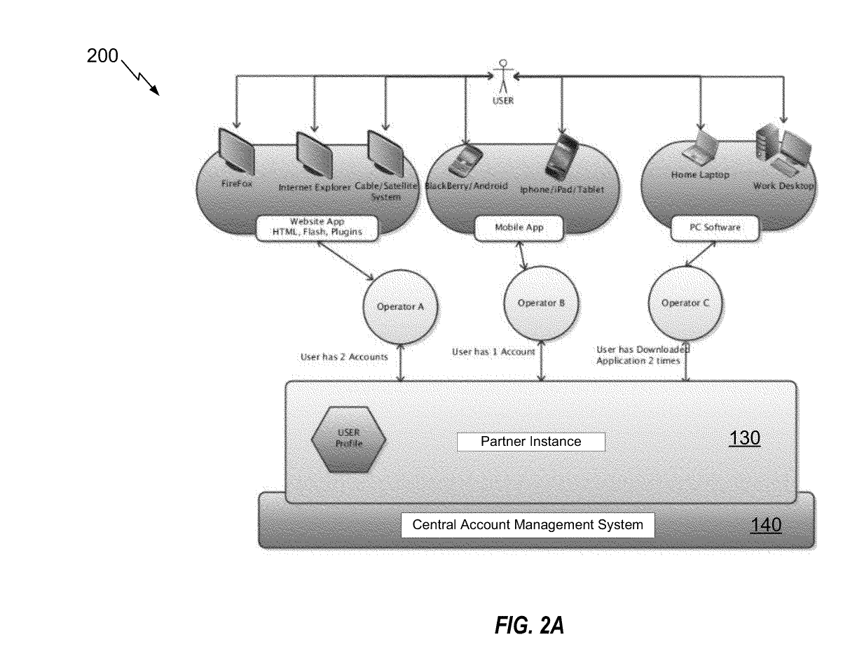

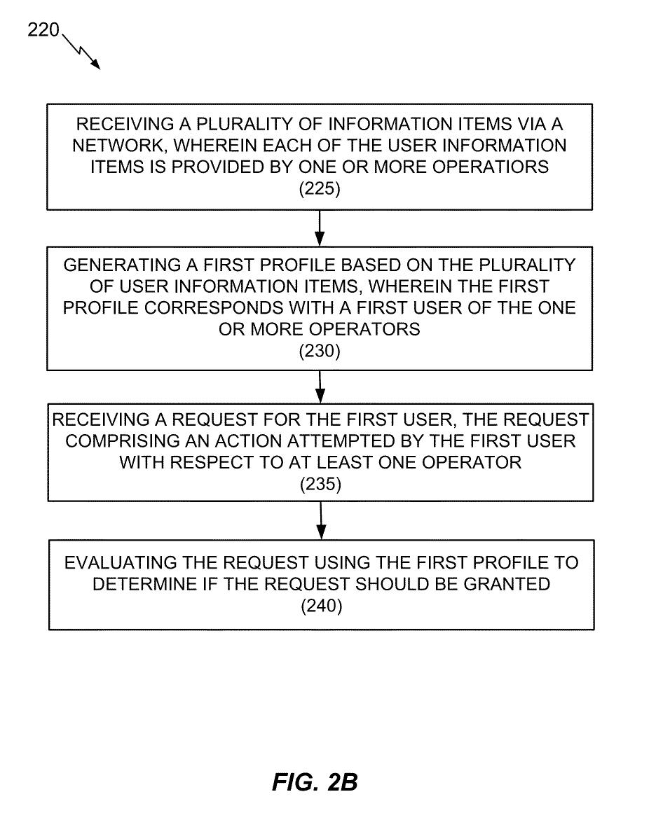

With reference to FIG. 2A, there are shown features of an example system 200 for generating a central account management system profile for a user. In one approach, central account management system 140 is not responsible for managing individual user accounts on behalf of the Operators A, B, and/or C. Rather, individual Operators can deploy their own user provisioning and account management.

In some aspects, central account management system 140 can take the operator user account parameters into consideration when creating the profile for the user. For example, the profile may include the following: operator user account information; user device characteristics; device linking; account linking across websites/software applications from different providers/Operators; Internet Protocol (IP), WiFi (based on the Institute of Electrical and Electronics Engineers' (IEEE) 802.11 standards), or Mobile geo-location data; account usage history; payment activity; user information (e.g., voice print, facial recognition scans, or the like); authentication activity; and/or the like.

In another approach (not shown), in addition to creating a user profile, the central account management system can also facilitate the establishment and managing individual user accounts on behalf of one or more of the operators.

It is noted that the Operators A, B, and/or C may be responsible for collecting the user information, and may provide the collected user information to the central account management system 140 or another Partner instance of the central account management system. In the alternative, or in addition, the online services or sites may collect user information, and may provide the collected user information to the central account management system 140 or the like. In the alternative, or in addition, the central account management system 140 can collect user information from end users and/or from third-party entities.

In the example shown in FIG. 2A, in system 200, the user profile can be generated and stored in the Partner instance 130 of the central account management system 140. The user may utilize the services of Operator A via website app(s) and mobile app(s). The user can utilize the services of Operator B via mobile app(s), and may utilize the services of Operator C via PC software. Examples of information used to create, or that are included in the user profile can include the number of accounts the user has with each of the operators and how many times the user has downloaded an app for a given operator.

FIG. 2B illustrates a process 220 for creating and implementing a user profile, for example, using a central account management system, such as that described above with respect to FIG. 2A. Process 220 begins with step 225, in which a plurality of information items are received by the central account management system. Receipt of the information items may be differently accomplished, depending on system topology. For example, information items can be received via a private local area network (LAN), or a wide area network (WAN), that connects Partner(s) or Operator(s) to the central account management system. Receipt of the information items can also occur over a public computer network, such as the Internet.

In certain aspects, the information items are provided by one or more operators, such as online wagering services. However, user information can be received from other sources, such as third party sites or networks, without departing from the scope of the invention.

Collected information items can include any information associated with a user (or groups of users) of the operator's services. User information items can include identification information that identifies one or more users, such as real or legal name(s), online name(s), such as, a screen name, and/or account information, such as an operator account number or ID. User information can also include data describing a user's online history (e.g., transaction history) or habits, for example, indicating patterns of user participation in the operator's service. By way of further example, user information can include an internet protocol (IP) address, social security number, driver's license number, government ID, passport number, credit score data, tax return data, background check data, personally identifiable information (PII), a user device ID, voiceprint, fingerprint, facial print, retinal print, hand print, casino-operator specific account data, or geo-location data for the user, etc.

By collecting user information items from multiple various operators, the central account management system can aggregate greater amounts of user information than would be practicable for a single operator, or small groups of operators. With access to larger quantities of data, the central account management system can more easily identify correlations between user information items and user preferences, which can be used to construct user profiles.

In step 230, a first profile is generated based on the plurality of user information items. By way of example, the generated profile can be that which is based on information items for a first user, e.g., who is a member/consumer of operator's services.

It is understood that generation of the first user profile can be performed in different ways, depending on the desired implementation. By way of example, a pre-existing profile template or profile model may be used to generate the profile using the received information items. As such, the generated profile profile (e.g., the first profile) can include qualitative and/or quantitative indicators that are extracted from data of the information items. The first profile can also include estimates of qualitative or quantitative characteristics of the associated user, which are not directly provided from the store of aggregated user data.

Once generated, the first profile can be provided for access by one or more operators, for example, to aid in making determinations as to whether to allow/disallow user actions or behaviors. In certain aspects, operator interaction with a user profile (which is managed by the central account management system) involves the forwarding of a user request from the operator to the central account management system. By evaluating the request, and returning a result to the originating operator, the central account management system can provide a centrally managed profiling service for multiple operators, without the need for duplicative user profiles.

In step 235, a request for the first user (e.g., indicating an action attempted by the first user with respect to at least one operator), is received by the central account management system. Requests may include indications of any action that can be attempted by the user, including but not limited to, requests to: make online wagers, move or withdraw funds, and/or modify betting amounts or limits, etc.

In step 240, the request is evaluated using the first profile to determine if the request should be granted. In certain aspects, evaluation of a request includes the use of data and/or rules in addition to the user profile. In certain implementations, evaluations can be made based on jurisdictional rules or regulations pertaining to the operator originating the request. Accordingly, the process of request evaluation can be performed on an operator-by operator-basis, or based on indications that an operator is a member of a particular group corresponding with a particular set of rules or restrictions.

By way of example, information identifying a group of operators (e.g., in a particular jurisdictional area such as Nevada) can be used to correlate regulatory restrictions with those operators. As such, when the central account management system receives a request, the request is evaluated using a profile of the associated member and in the context of rules or restrictions associated with the operator's group (i.e., regulatory restrictions for Nevada operators). By enabling evaluation of requests in conjunction with operator information, the subject technology can implement user profiling for a variety of tasks, including, but not limited to, user risk profiling and regulatory compliance.

In certain implementations, user profiles heavily influenced by information items related to a user's financial behavior (e.g., financial transaction history information, betting history, etc.), can be used to evaluate financial risks for the user. As such, the user profile can, in effect, function as a “risk profile” for determining financial constraints to be applied to the corresponding user.

In instances where no user profile is available for a particular user, the central account management system can still make determinations regarding permissible user behaviors and/or activities. For example, usage data can be used to make decisions about permissible activities, even where a user profile has not yet been created or completed. In some implementations, historical data for making decisions in the absence of a user profile can be gathered from third party sources, such as historical data gathered from a loyalty program (e.g., a casino loyalty program).

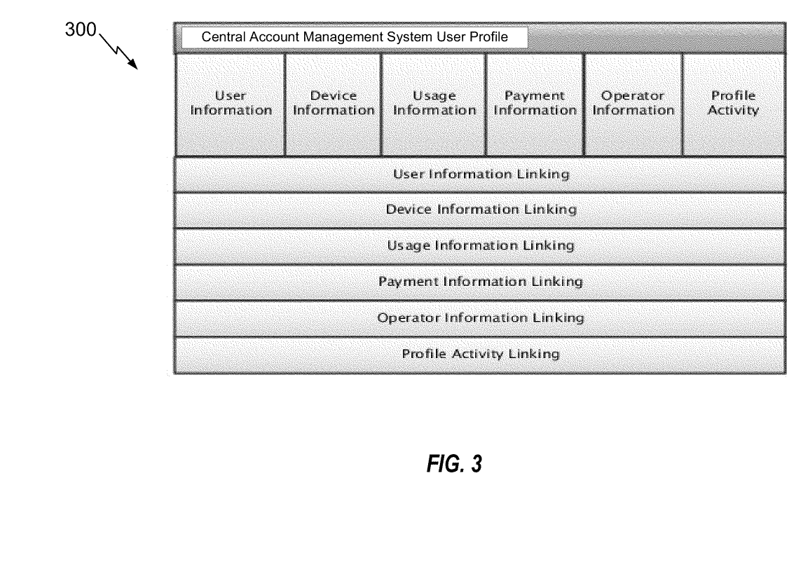

As shown in the example of FIG. 3, the user profile may include: user information; device information; usage information; payment information; Operator information; and/or profile activity. The user profile may also include linking for one or more of the above-listed information.

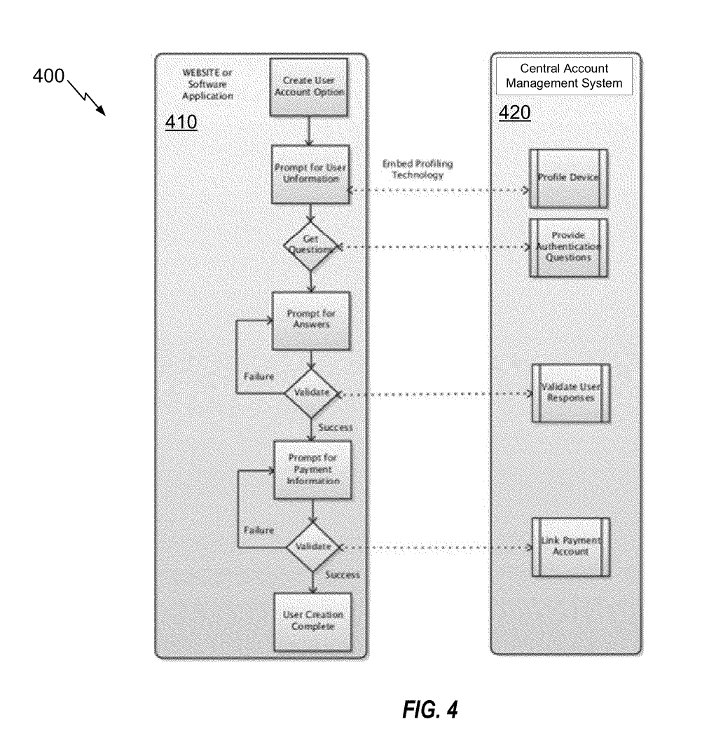

NEW USER REGISTRATION PROCESS: With reference to FIG. 4, there is shown an embodiment of a system 400 for registering a new user. For example, the system 400 may include an online service or software application 410 and a central account management system 420 for performing a new user registration process.

General aspects of the new user registration process may include one or more of the following: embedding the device profiling technology into the user profile creation process; tracking the time it takes to complete the process; tracking the position of the clicks on the buttons; detecting automated account creations scripts; risk based authentication to validate first time account creation; setting up multiple forms of authentication for return user account verification (e.g., email, short message service (SMS), phone calls, secure token mobile app, voice recognition, facial recognition, retinal recognition, video/picture based authentication, mutual authentication allowing the user to select an image which will be used on subsequent logins wherein the user is expected to enter their account details only when the selected image is displayed, etc.); pre-defined conditions wherein certain profiling characteristics have different levels of initial account verification; and/or the like.

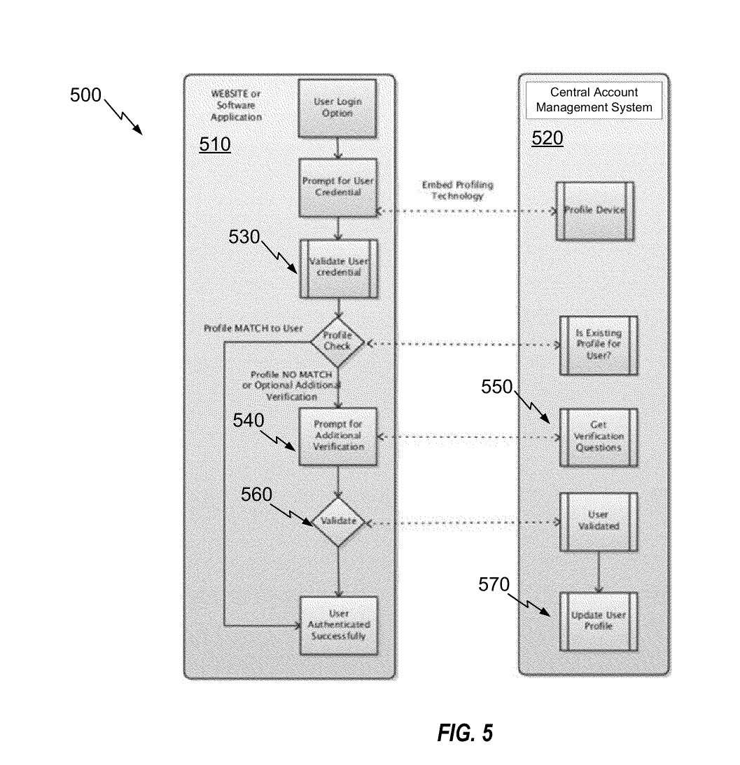

With reference to the example system 400 of FIG. 4, the Operator online service (or software application) 410 may enable the user to create a user account in order to participate in online wagering. During the user creation process, the Operator online service 410 may integrate with the central account management system 420 enabling the central account management system 420 to collect user information, compare information to existing user profiles, register the user, authenticate the user, and/or enable the user to fund their profile account with the Operator 410. It is noted that the Operator 410 may collect the user information and submit it to the central account management system 420 for processing. In the alternative, or in addition, the central account management system 420 may directly collect the user information. It is further noted that the system 420 may include or be a Partner instance 130 (not shown) of the central account management system 420 (see FIGS. 1-2). The Partner instance 130 of the system 420 may interface the Operator 410 and/or other network entities (e.g., payment network(s) or the like) of the system 400. Similarly, the central account management systems shown in FIGS. 5-10 may also include one or more Partner instances 130 that interface with the Operator(s), payment network(s), and/or other network/system entities.

RETURNING USER AUTHENTICATION: With reference to FIG. 5, there is shown an embodiment of an illustrative system 500 for returning user authentication. For example, the system 500 may include an online service or software application 510 and a central account management system 520 for performing a returning user authentication process. During the returning user authentication process, the Operator website 510 may integrate with the system 520, thereby enabling the collection of user information by the system 520 for purposes of user identification and authentication. The Operator 510 may employ their own user authentication techniques at 530, as well as leverage the system 520 for additional user authentication at 540. In the event that the returning user is using an unregistered device or is from an unrecognized location, secondary user account verification steps may be taken to verify the identity and location of the returning user. The system 520 may leverage internal data or external data to support the user authentication process at 550. In this embodiment, the system 520 may return the outcome of the user authentication at 560 to the Operator's website or software application 510, and may update the user's profile at 570 within the system 520.

General aspects of the returning user authentication process may include one or more of the following. Device profiling technology may be embedded into the returning user authentication process. User authentication and profile association may be performed during the user login process. Once the user is successfully logged into the Operator's application/website 510, the user's activity may be recorded as part of the user's profile. The user may be promoted for their user identification and verification credentials. The user may be optionally prompted for additional forms of verification, and may involve risk based authentication (e.g., out of pocket questions), secondary forms of authentication (e.g., ID verification, voice verification), etc.

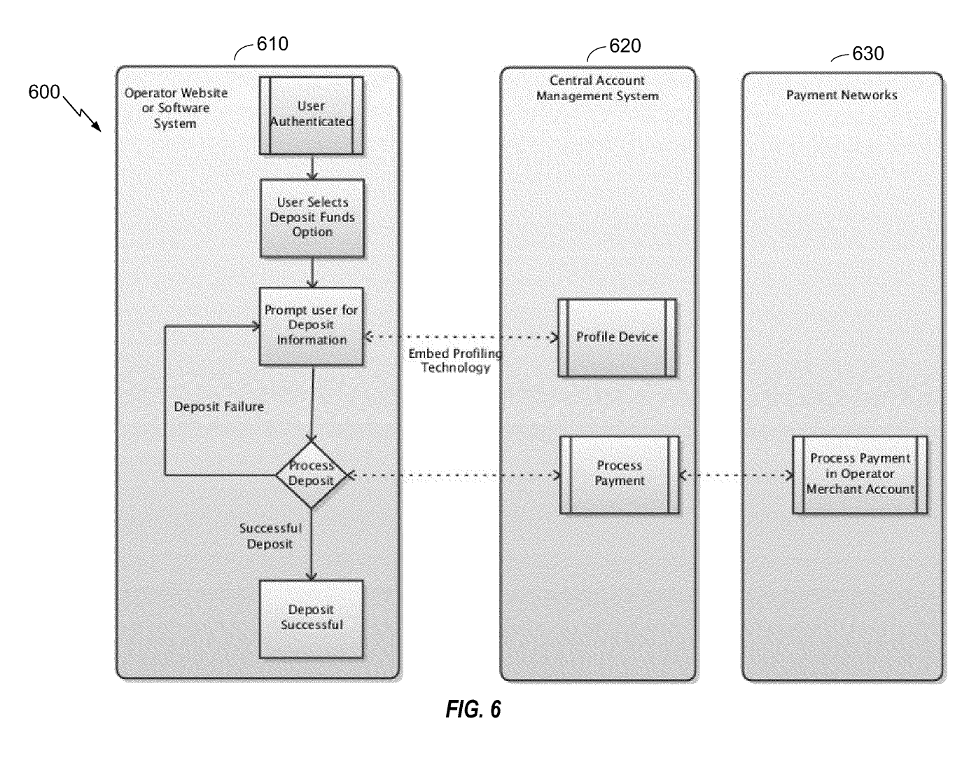

OPERATOR USER ACCOUNT FUNDING: With reference to FIG. 6, there is shown an embodiment of a system 600 that includes an Operator system 610, a central account management system 620, and payment network(s) 630. The Operator system 610 may authenticate a new or returning user(s). A given user may select the deposit funds options from the Operator system 610. For example, the Operator system 610 may prompt the user for deposit information. The central account management system 620 may facilitate the processing of payment transaction between the user and the Operator 610. The system 620 may accept the user payment information from the Operator 610 and may process the request with the Operator's merchant account payment processor or the like at the payment network(s) 630. In another approach (not shown), the system 620 may directly interface with the user on behalf of the Operator 610 to collection payment information and to facilitate the payment transaction with the payment networks(s) 630 or the like.

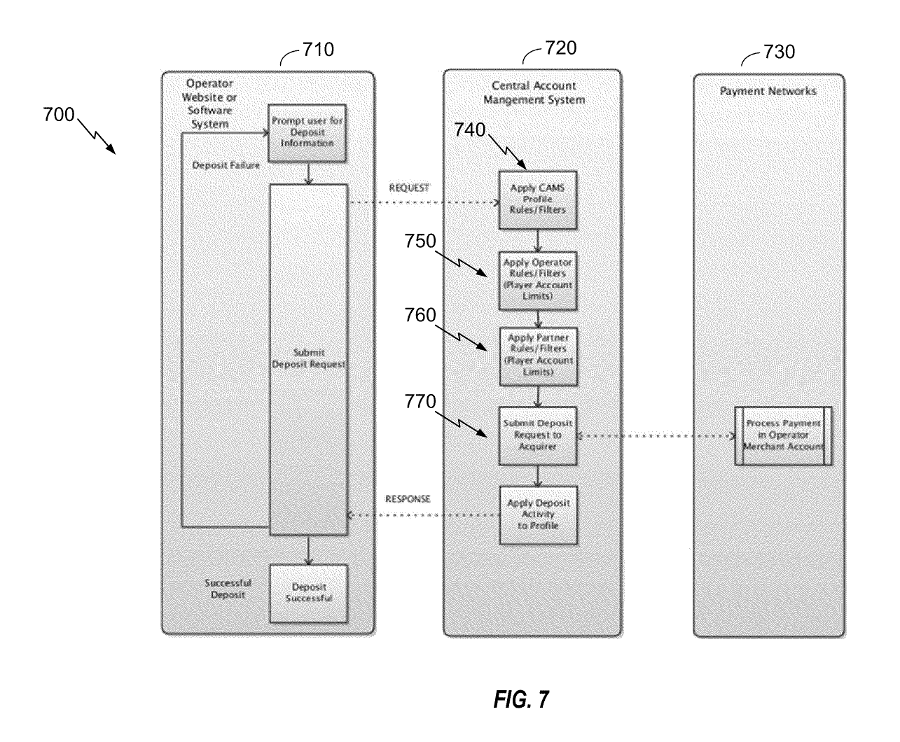

DEPOSIT PAYMENT PROCESS: With reference to FIG. 7, there is shown an embodiment of a system 700 that includes an Operator system 710, a central account management system 720, and payment network(s) 730. In response to receiving a deposit request from the Operator system 710, the central account management system 720 may apply one or more profile rules or filters at 740. The system 720 may apply Operator rules/filters at 750. The system 720 may apply Partner rules or filters at 760, such as, for example, at least one player account limit (PAL) or the like. The system 720 may submit a deposit request at 770 to a merchant account acquirer payment processor or the like at the payment network(s), and may apply a deposit activity to the user profile.

In related aspects, the system 720 may apply one or more PALs. For example, there may be one or more levels of account limit configurability: user-defined; Operator-defined; and/or Partner-defined. The user-defined PAL may include self-exclusion, personal user limits, limits of deposits within a pre-determined time period, or the like. The deposit activity may be associated with the user profile and be applied across a plurality of one or more payment instruments, rather than an individual credit card number or the like.

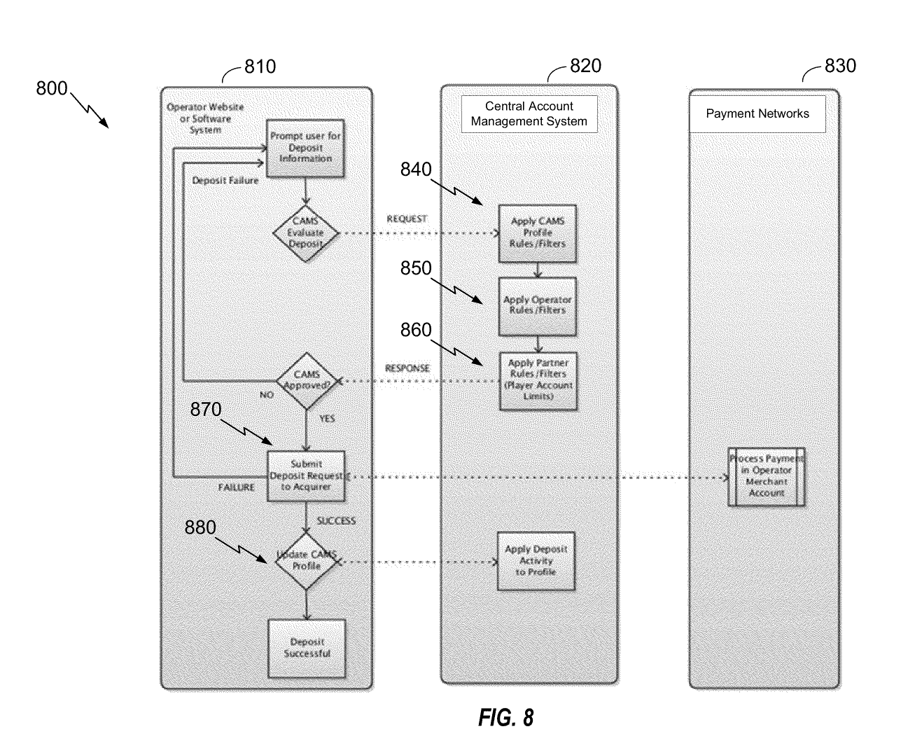

DEPOSIT SEQUENCE: With reference to FIG. 8, there is shown an embodiment of a system 800 that includes an Operator system 810, a central account management system 820, and payment network(s) 830. In the illustrated example of FIG. 8, the central account management system 820 does not provide payment connectivity to the banking networks. It is noted that the system 820 may apply one or more PALs. As noted above, there may be one or more levels of account limit configurability: user-defined at 840; Operator-defined at 850; and/or Partner-defined at 860. The user-defined PAL may include self-exclusion, personal user limits, limits of deposits within a pre-determined time period, or the like. The Operator system 810 may submit a deposit request at 870 to the merchant account payment processor or the like at the payment network(s), and may apply a deposit activity at 880 to the user profile.

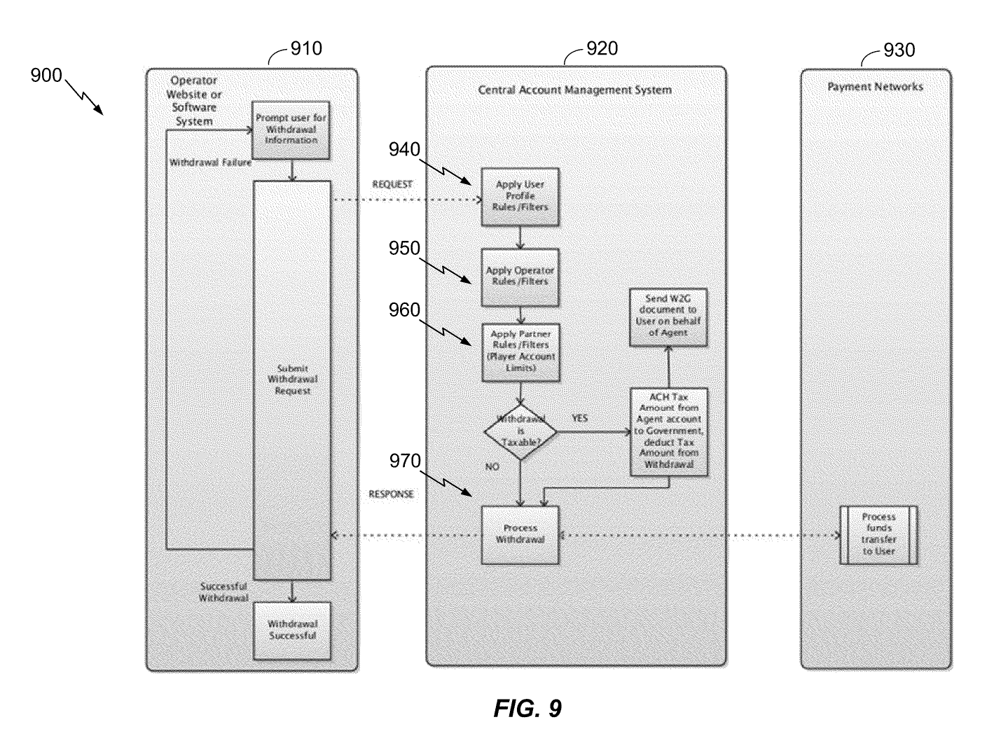

With reference to FIG. 9, there is shown an embodiment of a system 900 that includes an Operator system 910, a central account management system 920, and payment network(s) 930. In response to receiving a withdrawal request from the Operator system 910, the system 920 may apply one or more user profile rules or filters a 940. The system 920 may apply Operator rules/filters at 950. The system 920 may apply Partner rules or filters at 960, such as, for example, at least one PAL or the like. The system 920 may submit a withdrawal request at 970 to the merchant account payment processor or the like at the payment network(s). The outcome of the withdrawal request may be returned to the Operator system 910.

Compliance and enforcement of tax withholdings (e.g., state and/or federal, U.S. and/or other countries) may be implemented by the system 900 at the Operator 910 and/or at the Partner level. Withdrawals (funds transferred from the Operator 910 to user/consumer) may be transferred to one or more bank/financial accounts, and may be split across one or more financial instruments. Depending on regulatory requirements, a portion (partial or full) of the withdrawal maybe executed by reversing the original charge/deposit of the credit card transaction, original deposit transaction, or the like.

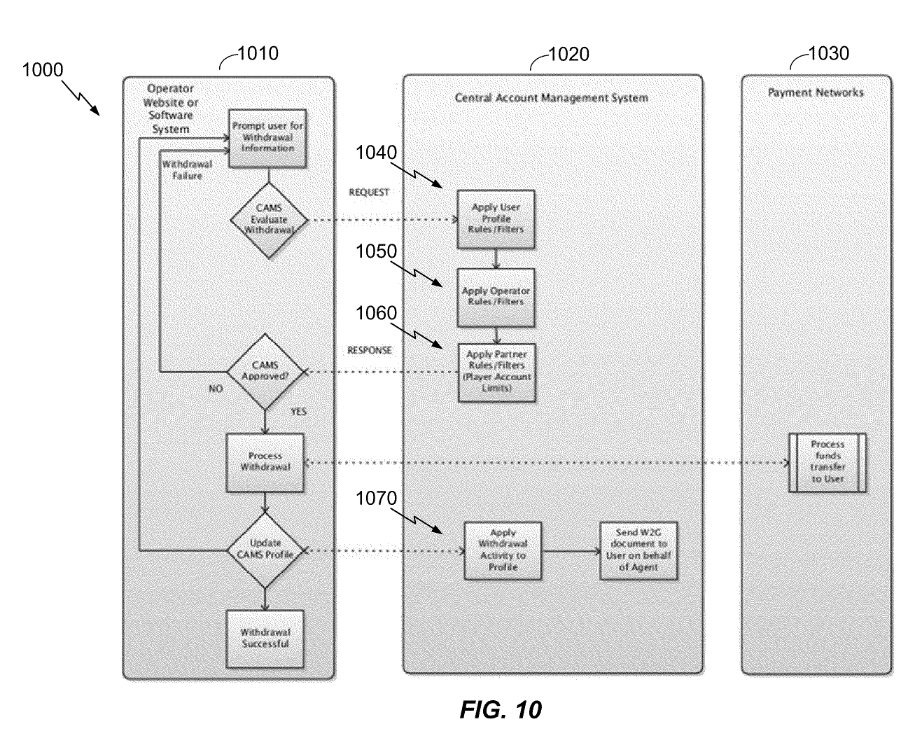

WITHDRAWAL PROCESS, WHEN THE SYSTEM IS NOT PROVIDING PAYMENT CONNECTIVITY TO THE BANKING NETWORKS: With reference to FIG. 10, there is shown an embodiment of a system 1000 that includes an Operator system 1010, a central account management system 1020, and payment network(s) 1030. The system 1020 may apply one or more PALs or the like. For example, there may be one or more levels of account limit configurability, such as, for example: user-defined at 1040; Operator-defined at 1050; and/or Partner-defined at 1060. The user-defined PAL may include self-exclusion, personal user limits, limits of deposits within a pre-determined time period, or the like. The Operator system 1010 may submit a funds transfer request to the merchant account payment processor or the like at the payment network(s), and may notify the central account management system 1020 of the withdrawal activity at 1070 to the user profile.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

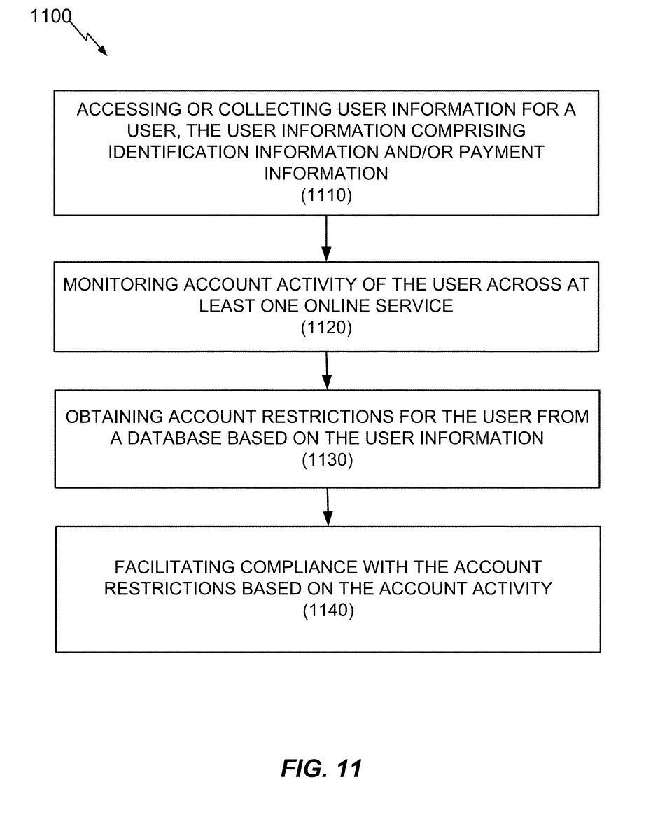

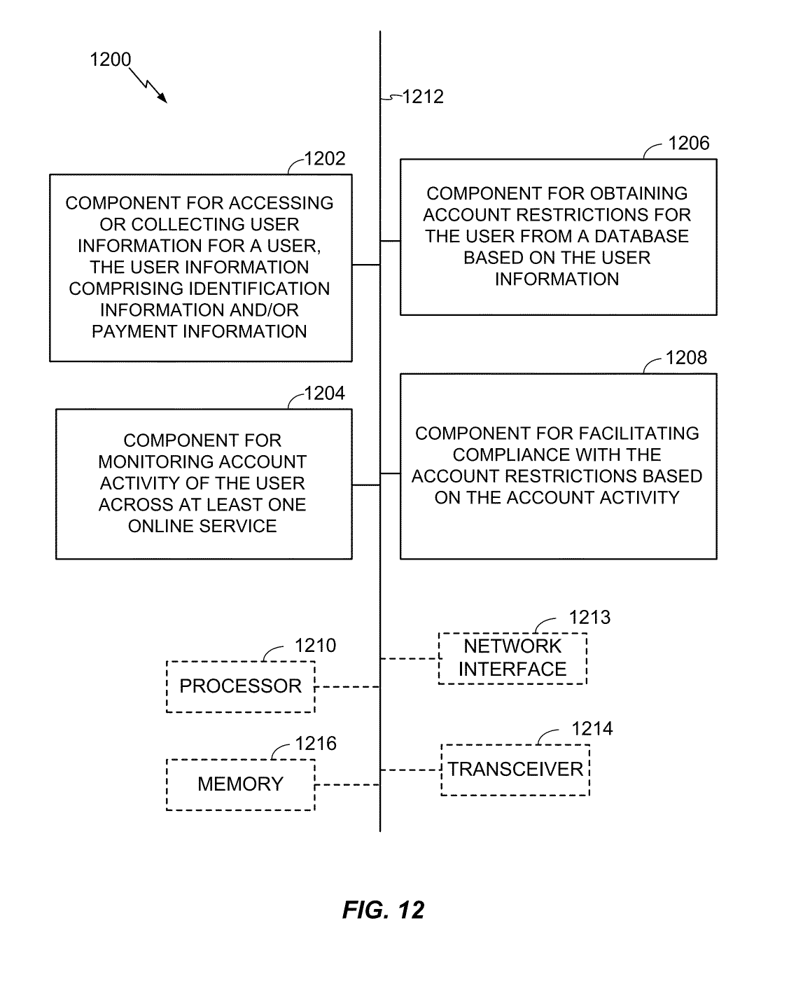

In accordance with one or more aspects of the embodiments described herein, there is provided a technique operable by at least one network entity (e.g., at least one server or the like) for managing an online service account. For example, the at least one server may include a multi-tenant SaaS component or the like. With reference to the example of FIG. 11, there is shown a methodology 1100 that may involve accessing or collecting user information for a user (e.g., collecting the user information from the user or a third-party entity), the user information comprising identification information and/or payment information (block 1110). For example, block 1110 may be performed by a processor working in conjunction with a network interface and/or transceiver (e.g., the processor 1210, the network interface 1213, the transceiver 1214, and/or the component/module 1202 in FIG. 12). The method 1100 may involve monitoring account activity of the user across at least one online service (block 1120). For example, block 1120 may be performed by a processor (e.g., the processor 1210 and/or the component/module 1204 in FIG. 12).

The method 1100 may involve obtaining account restrictions for the user from a database based on the user information (block 1130). For example, block 1130 may be performed by a processor working in conjunction with a network interface and/or transceiver (e.g., the processor 1210, the network interface 1213, the transceiver 1214, and/or the module/component 1206 in FIG. 12). The method 1100 may involve facilitating compliance with the account restrictions based on the account activity (block 1140). For example, block 1140 may be performed by a processor and a memory (e.g., the processor 1210, the memory 1216, and/or the component/module 1208 in FIG. 12).

In related aspects, the user information may be locally stored at the network entity. The method 1100 may further involve gathering the user information to setup or update the online service account. In the alternative, or in addition, the user information may be stored on at least one remotely located server or the like.

In further related aspects, the identification information may include at least one of a social security number, driver's license number, government ID, a passport number, voiceprint, fingerprint, facial print, retinal print, hand print, credit score data, tax return data, background check data, personally identifiable information (PII), a user device ID, and geo-location data for the user.

In yet related aspects, the payment information may include at least one of credit or debit card account number, checking account data, alternative payment methods, pre-paid account data, e-commerce payment account data, LEC billing data, digital wallets, alternative payment data, instant banking, local exchange carrier (LEC) billing data, mobile billing data, near field communication (NFC) account data, casino-operator specific account data, casino credit data, social networking service specific credits, or other forms of digital currency.

In still related aspects, monitoring (block 1120) may involve tracking user's transactions at the at least one online service. Monitoring (block 1120) may involve communicating locally with a multi-tenant SaaS component or the like using synchronous and asynchronous methods. In the alternative, or in addition, monitoring (block 1120) may involve communicating with at least one remote server, the at least one remote server comprising an online service server or a payment processor server.

In related aspects, the database with the account restrictions may be stored locally at the network entity. In the alternative, or in addition, the database with the account restrictions may be stored on a remote server or the like. For example, the database with the account restrictions may be stored on the server operated by a government agency, a gamblers anonymous service, a credit monitoring service, or a law enforcement agency. In another example, the server with the database may be operated by an accredited third-party.

In further related aspects, the account restrictions may include at least one of an age limit, an outstanding balance limit, a number of transactions limit, and a defined deposit limit for a defined time period. Facilitating compliance (block 1140) may involve, in response to the account activity exceeding at least one limit of the account restrictions, notifying at least one of (a) the user, (b) the at least one online service (c) a gamblers anonymous service, (d) user's payment processor, (e) an enforcement entity, and (f) a Partner instance entity, regarding the user exceeding the at least one limit. The method 1100 may further involve maintaining a list of gamblers who have failed to comply with their respective account restrictions, the list being local to the network entity or stored in a remote database that is accessed by the network entity.

In yet further related aspects, the method 1100 may further involve obtaining tax liability/compliance information from the at least one online service or at least one tax agency, the tax liability information relating to state tax liability or federal tax liability. For example, the at least one tax agency may be the Internal Revenue Service (IRS). The method 1100 may further involve communicating with the at least one online service or at least one tax agency to facilitate the payment of taxes by the user.

In still further related aspects, the at least one online service may include at least one gambling service, and the online service account be a gambling account. The at least one online service may include a lottery site or a gaming site, and the online service account may be a lottery account or a gaming account.

In accordance with one or more aspects of the embodiments described herein, there are provided devices and apparatuses for managing online service accounts, as described above with reference to FIG. 11. With reference to FIG. 12, there is provided an exemplary apparatus 1200 that may be configured as a network entity (e.g., a specialized server) in an online or mobile network, or as a processor or similar device for use within the network entity. The apparatus 1200 may include functional blocks that can represent functions implemented by a processor, software, or combination thereof (e.g., firmware). The methodologies and techniques shown in FIG. 11 or described with direct or indirect reference to FIG. 11 may be performed by one or more of the components shown in FIGS. 1-10 and 12 or otherwise described herein.

As illustrated, in one embodiment, the apparatus 1200 may include an electrical component or module 1202 for accessing or collecting user information for a user, the user information comprising identification information and/or payment information. The apparatus may include a component 1204 for monitoring account activity of the user across at least one online service. The apparatus may include a component 1206 for obtaining account restrictions for the user from a database based on the user information. The apparatus may include a component 1208 for facilitating compliance with the account restrictions based on the account activity.

In related aspects, apparatus 1200 can include a processor component 1210 having at least one processor, in the case of apparatus 1200 configured as a network entity, rather than as a processor. Processor 1210, in such cases, can be in communication with components 1202-1208 via bus 1212 or similar communication coupling. Processor 1210 can effect initiation and scheduling of the processes or functions performed by electrical components 1202-1208.

In further related aspects, the apparatus 1200 may include a network interface 1213 and/or a transceiver component 1214. A stand alone receiver and/or stand alone transmitter may be used in lieu of or in conjunction with the transceiver 1214. Apparatus 1200 can optionally include a component for storing information, such as, for example, memory device/component 1216. The computer readable medium or the memory component 1216 may be operatively coupled to the other components of apparatus 1200 via bus 1212 or the like. Memory component 1216 can be adapted to store computer readable instructions and data for effecting the processes and behavior of components 1202-1208, and subcomponents thereof, or processor 1210, or the methods disclosed herein. Memory component 1216 may retain instructions for executing functions associated with the components 1202-1208. While shown as being external to memory 1216, it is to be understood that components 1202-1208 can exist within processor 1210 and/or memory 1216.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or non-transitory wireless technologies, then the coaxial cable, fiber optic cable, twisted pair, DSL, or the non-transitory wireless technologies are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A central account management system comprising one or more computers, wherein the one or more computers are configured to perform operations for:
receiving a plurality of user information items via a network, wherein each of the user information items is provided by one or more operators;
generating a first profile based on the plurality of user information items, wherein the first profile corresponds with a first user of the one or more operators;
receiving a request for the first user, the request comprising an action attempted by the first user with respect to at least one of the one or more operators; and
evaluating the request using the first profile to determine if the request should be granted.

2. The central account management system of claim 1, wherein the plurality of user information items comprises one or more of: user usage information, network information, or operator information.

3. The central account management system of claim 1, wherein the first user profile comprises a risk profile for the first user.

4. The central account management system of claim 3, wherein the risk profile for the first user is based on a betting history of the first user.

5. The central account management system of claim 3, wherein the risk profile for the first user is based on a geographic location of the first user.

6. The central account management system of claim 3, wherein the risk profile is used to determine a betting limit for the first user.

7. The central account management system of claim 1, wherein evaluating the request using the first profile is based on regulatory information provided by the one or more operators.

8. A method for building a user profile, the method comprising:
receiving a plurality of user information items via a network, wherein each of the user information items is provided by one or more operators;
generating a first profile based on the plurality of user information items, wherein the first profile corresponds with a first user of the one or more operators;
receiving a request for the first user, the request comprising an action attempted by the first user with respect to at least one of the one or more operators; and
evaluating the request using the first profile to determine if the request should be granted.

9. The method of claim 8, wherein the plurality of user information items comprises one or more of: user usage information, network information, or operator information.

10. The method of claim 8, wherein the first user profile comprises a risk profile for the first user.

11. The method of claim 10, wherein the risk profile for the first user is based on financial transaction history information of the first user.

12. The method of claim 10, wherein the risk profile for the first user is based on a betting history of the first user.

13. The method of claim 10, wherein the risk profile is used to determine a betting limit for the first user.

14. The method of claim 8, wherein evaluating the request using the first profile is based on regulatory information provided by the one or more operators.

15. A non-transitory computer readable medium comprising instructions stored therein, which when executed by one or more processors, cause the processors to perform operations comprising:
receiving a plurality of user information items via a network, wherein each of the user information items is provided by one or more operators;
generating a first profile based on the plurality of user information items, wherein the first profile corresponds with a first user of the one or more operators;
receiving a request for the first user, the request comprising an action attempted by the first user with respect to at least one of the one or more operators; and
evaluating the request using the first profile to determine if the request should be granted.

16. The non-transitory computer readable medium of claim 15, wherein the plurality of user information items comprises one or more of: user usage information, network information, or operator information.

17. The non-transitory computer readable medium of claim 15, wherein the first user profile comprises a risk profile for the first user.

18. The non-transitory computer readable medium of claim 17, wherein the risk profile for the first user is based on financial transaction history information of the first user.

19. The non-transitory computer readable medium of claim 17, wherein the risk profile for the first user is based on a betting history of the first user.

20. The non-transitory computer readable medium of claim 17, wherein the risk profile is used determine a betting limit for the first user.

21. The non-transitory computer readable medium of claim 15, wherein evaluating the request using the first profile is based on regulatory information provided by the one or more operators.

22. A central account management system comprising one or more computers, wherein the one or more computers are configured to perform operations for:
receiving a request for a first user, the request comprising an action attempted by the first user with respect to at least one operator;
determining that a user profile does not exist for the first user; and
in response to determining that the user profile does not exist, evaluating the request using historical data associated with the user to determine if the request should be granted.
